(19) United States
(12) Patent Application Publication
(10) Pub. No.: US 2003/0178268 A1
(43) Pub. Date: Sep. 25, 2003

(54) Suspension damper mounting ring casting with steel insert

(75) Inventors: Venkatasubramanian Ananthanarayanan, Beavercreek, OH (US); Stephen C. Hagwood, Centerville, OH (US); Essam E. Salama, West Chester, OH (US)

Correspondence Address: DELPHI TECHNOLOGIES, INC., Legal Staff, 1450 W. Long Lake, P.O. BOX 5052, Mail Code: 480-414-420, Troy, MI, 48098, US

(73) Assignee: DELPHI TECHNOLOGIES INC.

(21) Appl. No.: 10/105,542

(22) Filed: Mar. 25, 2002

(51) Int. Cl. F16F 9/00

(52) U.S. Cl. 188/321.11

(57) ABSTRACT

A method of forming an attachment fitting for a suspension tube comprises providing an insert in a mold, and casting a ring element in the mold. The ring element is metallurgically bonded to the insert. An attachment fitting formed by this method is also disclosed.

### TECHNICAL FIELD OF THE INVENTION

The present invention relates to motor vehicle suspension, and more particularly to a mounting ring casting with a steel insert.

### BACKGROUND OF THE INVENTION

A damper operates in vehicle suspensions as a damping device controlling the sprung (body) and unsprung (wheels) masses of a vehicle by reducing loads or vertical accelerations normally transmitted from the wheels to the body. Damping is accomplished by converting kinetic energy into thermal energy and dissipating the heat. Conventionally, hydraulic dampers include a piston with a connected piston rod slidably carried in a fluid-filled tube and separating the tube into extension and compression chambers. A rod guide at the top end of the tube closes the extension chamber and slidably engages the piston rod. The piston rod and the tube are provided with attachment fittings for connection to the sprung and unsprung masses. Due to the operating environment of the damper, the fittings must be securely connected to withstand the applied forces. Often, the attachment fitting connected to the tube is secured by a welding process since this can be accomplished during the initial stages of assembly when the tube is dry, prior to the addition of hydraulic fluid.

The attachment fitting connected to the piston rod is generally secured by a threaded joint. This is because the piston rod fitting is attached after the damper is assembled and filled with oil, since assembly of the damper's internal components requires access over the end of the rod. Completing the threaded joint requires threading the rod's end, threading a matching component to be joined to the attachment fitting, mounting that component to the attachment fitting without deforming the threads, and assembling the two threaded parts. Generally, it is known that a welded joint is an alternative to a threaded joint. Complications in welding a piston rod fitting to a substantially assembled damper exist. The joint is not easily amenable to resistance welding since axial loads on the rod of several hundred pounds would be required.

Monotube strut mounting rings normally consist of a cast nodular cast iron ring element, a cover plate gasket, a low carbon steel cover plate and a retainer ring. The cast iron ring element provides good fatigue strength for the application, and the carbon steel cover plate provides weldability to the strut tube. The cover plate also provides freedom from casting porosity on the surface in contact with the strut oil. The gasket seals the surface between the cover plate and the ring element from leaking oil.

### SUMMARY OF THE INVENTION

The present invention is a method of forming an attachment fitting for a suspension tube. The method comprises providing an insert in a mold, and casting a ring element in the mold. The ring element is metallurgically bonded to the insert.

Accordingly, it is an object of the present invention to provide a method of the type described above that is less expensive and uses fewer pieces than prior art methods.

Another object of the present invention is to provide an attachment fitting which does not need to be machined extensively to ensure concentricity and provide a good sealing surface for the gasket.

Still another object of the present invention is to provide an attachment fitting which inhibits oil leaks.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a cross-sectional view of a portion of a suspension damper according to the present invention;

FIG. 2 is a perspective view of an attachment fitting of the damper; and

FIG. 3 is a cross-sectional view of the attachment fitting.

### DETAILED DESCRIPTION OF THE PRESENTLY PREFERRED EMBODIMENT

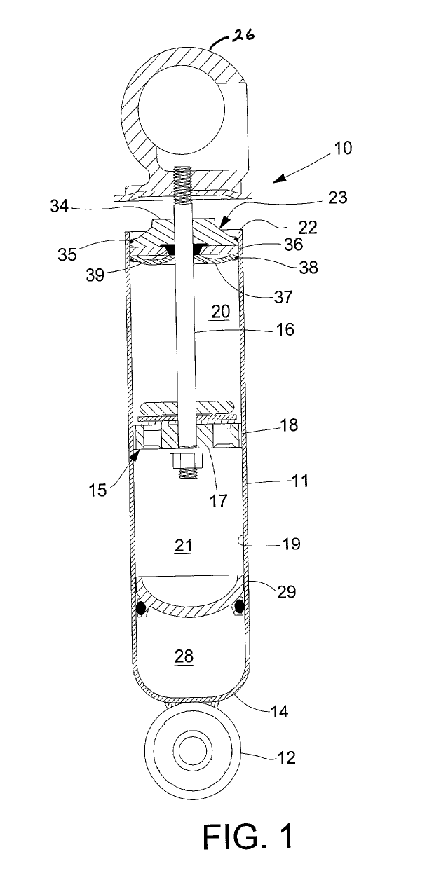

FIG. 1 shows one embodiment of a suspension damper 10 according to the present invention for a motor vehicle. The monotube damper 10 includes an elongated cylindrical tube 11 having an attachment fitting 12 secured thereto for connection to a wheel assembly (not illustrated) as the unsprung mass in the vehicle suspension system. The tube 11 is closed at its lower end by a base cup 14 that is secured thereto through conventional means such as welding, or is formed as an integral part thereof. The damper 10 includes a piston assembly 15 slidably mounted for reciprocal movement in the tube 11 and affixed to a piston rod 16. Damping piston assembly 15 includes a steel piston body 17 that carries a band of low friction material 18 sealingly and slidably engaging the inner wall 19 of tube 11. The piston assembly 15 hydraulically separates the interior of tube 11 into expansible and contractible working chambers designated as extension chamber 20 and compression chamber 21.

An upper end 22 of the tube 11 is in general provided with fastening devices such as snap rings and grooves, or is otherwise formed to securely carry a rod guide assembly 23. The piston rod 16 extends through the extension chamber 20 and rod guide assembly 23, and exits the tube 11. An attachment fitting 26 is threaded onto and/or otherwise suitably engaged with the end of the piston rod 16, as described below. The attachment fitting 26 is provided for attachment to the body of the vehicle (not illustrated) as the sprung mass of the suspension system. In response to relative movement between the wheel assembly and the vehicle, the damping piston assembly 15 reciprocally moves within the tube 11.

Oil carried in the tube 11 provides a damping medium for the damper 10. During a compression stroke, as the piston assembly 15 slides downward in the tube 11, an increasing volumetric amount of the piston rod 16 enters the tube 11 through the rod guide assembly 23. To accommodate this increased volume, a compressible gas charge is carried within a compensation chamber 28 which is separated from the compression chamber 21 by a reciprocal gas cup assembly 29. As the increasing amount of the piston rod 16 enters the tube 11 during the compression stroke, the gas within the compensation chamber 28 is compressed as the gas cup assembly 29 slides downward in response to displacement of the noncompressible hydraulic fluid carried within the compression chamber 21 and extension chamber 20.

The rod guide assembly 23 includes a metal rod guide body 34 surrounding piston rod 16. The rod guide body 34 is fixed in the end 22 of tube 11 by a snap ring 35 and provides lateral support and a bearing surface for the piston rod 16. An annular static seal 36 is carried against the rod guide body 34 and is securely sealed therewith, and with the inner wall 19 of tube 11. Dynamic seal 39 is carried about the piston rod 16 providing a fluid tight closure at the rod guide assembly 23, and is positioned between the rod guide body 34 and the static seal 36. A flask 37 is fixed against static seal 36 and is maintained in position by a snap ring 38 that engages tube 11.

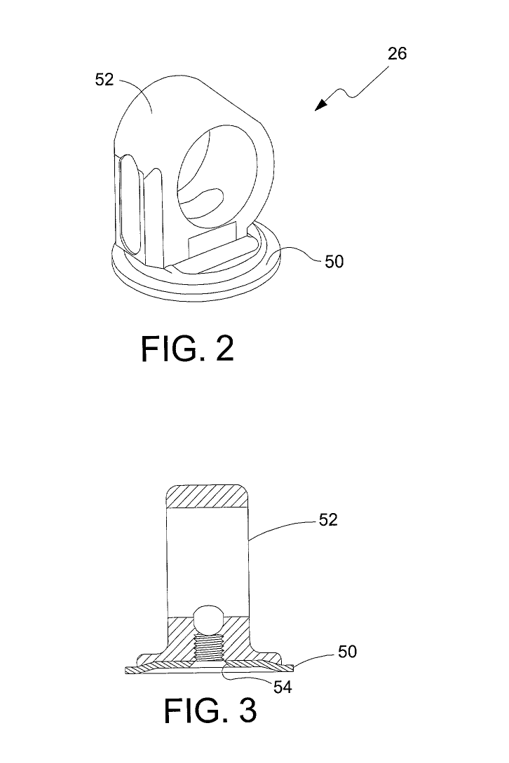

FIGS. 2 and 3 show the attachment fitting 26 in greater detail. The attachment fitting 26 includes an insert 50 metallurgically bonded to a mounting ring element 52. The insert 50 may be blanked from a relatively low carbon or mild steel, and formed with a beveled central opening 54. The insert 50 may then be placed in a mold while the ring element 52 is cast. In a preferred embodiment, the ring element 52 is a one-piece, nodular or other iron casting that provides relatively high fatigue strength and machineability. The finished hole through the insert 50 and the threads in the ring element 52 can be drilled and/or machined in a finishing operation that ensures concentricity.

The piston rod 16 extends through the central opening 54, and may be threadingly engaged with the ring element 52. The steel insert 50 may then be welded to a dust tube (not shown) in any known manner, including according to U.S. Pat. No. 5,896,960, the disclosure of which is hereby incorporated by reference. The dust tube, when clamped to a rubber sleeve, serves to contain oil and air under pressure to serve as an air spring. The insert 50 provides a wrought surface with no porosity to contain the strut oil, and thereby functions as a cover plate to seal the damper 10. No gasket is required between the ring element 52 and the insert 50, nor is a retainer ring required for retaining a multiple-piece attachment fitting as with some prior art designs. The elimination of these parts achieves a cost savings during manufacture.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of forming an attachment fitting for a suspension damper, the method comprising:
providing an insert in a mold; and
casting a ring element in the mold, the ring element metallurgically bonding to the insert.

2. The method of claim 1 further comprising blanking the insert.

3. The method of claim 1 further comprising drilling a hole through the insert and the ring element.

4. The method of claim 1 further comprising attaching the insert to the damper.

5. The method of claim 1 further comprising welding the insert to the damper.

6. The method of claim 1 wherein the insert is steel.

7. The method of claim 1 wherein the insert is low carbon steel.

8. The method of claim 1 wherein the ring element is iron.

9. The method of claim 1 wherein the ring element is nodular iron.

10. A method of forming an attachment fitting for a suspension damper, the method comprising:
blanking an insert;
providing an insert in a mold;
casting a ring element in the mold, the ring element metallurgically bonding to the insert; and
drilling a hole through the insert and the ring element.

11. The method of claim 10 further comprising attaching the insert to the damper.

12. The method of claim 10 further comprising welding the insert to the damper.

13. The method of claim 10 wherein the insert is low carbon steel.

14. The method of claim 10 wherein the ring element is nodular iron.

15. A suspension damper comprising:
an attachment fitting including a ring element metallurgically bonded to an insert; and
a tube attached to the insert.

16. The suspension damper of claim 15 wherein the attachment fitting has a hole adapted to accept a piston rod.

17. The suspension damper of claim 15 wherein the tube is welded to the insert.

18. The suspension damper of claim 15 wherein the insert is low carbon steel.

19. The suspension damper of claim 15 wherein the ring element is nodular iron.
